(19) United States
(12) Patent Application Publication
(10) Pub. No.: US 2010/0115916 A1
(43) Pub. Date: May 13, 2010

(54) NACELLE FOR TURBOJET JET FITTED WITH A SINGLE DOOR THRUST REVERSER SYSTEM

(75) Inventors: Alain D'Inca, Briis s/s Forges (FR); Thierry Martin, Maurecourt (FR)

Correspondence Address: CANTOR COLBURN, LLP, 20 Church Street, 22nd Floor, Hartford, CT, 06103, US

(73) Assignee: AIRCELLE, Gonfreville L'Orcher (FR)

(21) Appl. No.: 12/594,750

(22) PCT Filed: Apr. 2, 2008
(86) PCT No.: PCT/FR2008/000454

§ 371 Date: Oct. 5, 2009

(30) Foreign Application Priority Data
Apr. 12, 2007 (FR) 0702658

(51) Int. Cl. F02K 3/02

(52) U.S. Cl. 60/226.2

(57) ABSTRACT

A nacelle for a turbojet includes an air inlet structure capable of channeling an air flow toward a fan of the turbojet, a middle structure designed to surround the fan and a downstream section fitted with a pivoting-door thrust reverser system having a single thrust reverser door mounted so as to pivot between a closed position in which it allows an air flow to travel from the turbojet in a direct jet and in which it ensures the internal and external aerodynamic continuity of the nacelle and an open position in which it pivots toward a position substantially perpendicular to the axis of the nacelle, a downstream portion of the door moving inside the nacelle to close off at least a portion of the air flow of the turbojet and direct it in a direction oriented toward the front of the nacelle, where the downstream section has, downstream of the door, a ring extending over the whole periphery.

### TECHNICAL FIELD OF THE INVENTION

The present invention relates to a nacelle for a turbojet comprising an air inlet structure capable of channeling an air flow toward a fan of the turbojet, a middle structure designed to surround said fan and a downstream section fitted with a pivoting-door thrust reverser system.

### BRIEF SUMMARY OF RELATED ART

The role of a thrust reverser during landing of an aircraft is to improve the braking capacity of an aircraft by redirecting forward at least a portion of the thrust generated by the turbojet. In this phase, the reverser obstructs the gas exhaust nozzle and directs the exhaust flow from the engine toward the front of the nacelle, thereby generating a counterthrust which adds to the braking of the aircraft wheels.

The means used to achieve this reorientation of the flow vary depending on the type of reverser. However, in all cases, the structure of a reverser comprises movable covers that can be moved between, on the one hand, a deployed position in which they open in the nacelle a passageway designed for the diverted flow, and, on the other hand, a retracted position in which they close this passageway. These movable covers may also fulfill a function of diverting or simply of activating other diversion means.

In reversers with grilles, for example, the movable covers slide along rails so that, in retreating during the opening phase, they reveal grilles of diverter blades arranged in the thickness of the nacelle. A system of link rods connects this movable cover to blocking doors which deploy inside the exhaust channel and block the direct flow outlet. In reversers with doors, on the other hand, each movable cover pivots so as to block the flow and divert it and is therefore active in this reorientation.

The best known reversers are those with two doors diametrically opposed to one another, and those with four doors. For obvious reasons of balance and distribution of the forces applied by the air flow on the doors in the thrust reverser position, the reversers with doors have an even number of doors uniformly distributed over the periphery of the nacelle.

Considering that each door has actuation means and corresponding locking means, there is a need for solutions that make it possible to simplify and lighten said actuation and locking means while providing adequate efficiency of the thrust reverser system.

Also known are single-door reversers whose operation relies on a particular contour of the exhaust section. Particular mention will be made of document EP 0 131 079 which comprises a door having a spade shape making it possible to close off virtually all of the exhaust section during the reverser phase. The downstream portion of the door therefore has a substantially V-shaped contour.

In the direct jet position, this contour has several disadvantages. Specifically, the shape of the outlet section, determined by this contour at the far downstream end of the door, is not annular, but has notches situated substantially at articulation points of the door.

It also follows that the thickness of the outlet section is not constant and not thin.

This is very disadvantageous in terms of aircraft performance since it causes an overconsumption of fuel.

Document U.S. Pat. No. 3,874,620 also describes a door-based reverser comprising only one door. However, such a system requires the aid of the airfoils to optimize the blocking of the flow. It therefore has limitations with respect to the installation of the nacelle on the aircraft.

Finally, document GB 2 075 447 has a door-based reverser comprising a single door and having no contour problems. This contour is made unnecessary by the fact that the articulations of the door are situated as far as possible downstream of the latter, virtually at the exhaust level. On the other hand, it is impossible for said door to block virtually all of the flow and reverse it efficiently.

### BRIEF SUMMARY OF THE INVENTION

The invention remedies the aforementioned disadvantages, and particularly to optimize the efficiency of the thrust reverser systems with a single pivoting door and consequently relates to a nacelle for a turbojet comprising an air inlet structure capable of channeling an air flow toward a fan of the turbojet, a middle structure designed to surround said fan and a downstream section fitted with a pivoting-door thrust reverser system, comprising a single thrust reverser door mounted so as to pivot between a closed position in which it allows an air flow to travel from the turbojet in a direct jet and in which it ensures the internal and external aerodynamic continuity of the nacelle and an open position in which it pivots toward a position substantially perpendicular to the axis of the nacelle, a downstream portion of said door moving inside the nacelle to close off at least a portion of the air flow of the turbojet and direct it in a direction oriented toward the front of the nacelle, characterized in that the downstream section has, downstream of the door, a ring extending over the whole periphery.

Therefore, in addition to the fact that a nacelle comprising a single-door thrust reverser system allows a considerable weight gain, typically lying between 15 and 20%, the presence of a downstream peripheral ring makes it possible to dispense with the contour profile of the end of said door. Specifically, the ring has a downstream contour which may be optimized depending on the shape of the desired exhaust section and an upstream contour that will match the contour profile of the end of the door.

The outlet section therefore dispenses with the shape of the door and it will be possible to provide an outlet section that is thin and is of constant thickness over the exhaust periphery.

Typically, a thin section will have a thickness lying between 3 and 5 mm.

The stream is then closed off by the single contour of the generally concave-shaped door, which therefore makes it possible to have an efficient outlet section making it possible to optimize the performance of the engine in flight and in particular to reduce fuel consumption.

Advantageously, the ring forms an exhaust nozzle.

Preferably, the pivoting door is designed to make it possible to open up, upstream of its pivot axis, a reverse jet discharge section equal to twice the section closed off by said door in the reverse thrust position.

Specifically, the presence of a single thrust reverser door means providing a bigger door than on the conventional multidoor systems in order to ensure a thrust-reverser efficiency close to the conventional multidoor systems. It follows that this larger door, when it is opened, opens up a larger corresponding orifice in the nacelle. Access to the inside of the nacelle to carry out maintenance operations is thereby made much easier. By combining this advantage of a larger door with a possible concentration of the systems because of their reduced size and number, it is totally envisageable to dispense with one or more movable covers which, with smaller reverser doors, would still be necessary to allow access to the inside of the nacelle. In addition, the removal of these movable covers reduces the number of aerodynamic unevennesses on the outside of the nacelle.

It will be noted finally that a considerable fixed structure allows said structure to be produced with a reduced number of parts connected together. The logical result of this is a reduction in aerodynamic unevennesses that are caused by the connections between parts both on an inner surface of the nacelle exposed to the air flow of the turbojet and on an outer surface exposed to the air flow surrounding the nacelle.

Advantageously, the thrust reverser system comprises a single door actuation means fixed upstream of the latter substantially on a longitudinal midline. This simplifies the supply of the activation means, for example, in the supply network of a hydraulic or pneumatic cylinder.

Preferably, the thrust reverser system comprises means for locking the door in the closed position taking the form of a shear pin capable of interacting with a matching bore arranged in the thickness of the door.

Again preferably, the bore has a diameter that is greater than the diameter of the matching shear pin and is situated in an eccentric manner relative to said pin so that, in the closed position, the pin exerts a pressure against an inner surface of the bore and requires an overretraction in order to be engaged and/or disengaged without force.

Preferably, the downstream section has a fixed structure comprising an outer surface and an inner surface, said inner and/or said outer surface each being made in a single piece, the fixed structure then preferably being obtained by fitting together the two structures of substantially frustoconical shape.

Advantageously, the downstream section has, upstream of the door, a front frame extending over the whole periphery of the downstream section.

The present invention also relates to an aircraft characterized in that it is fitted with at least a pair of propulsion assemblies each comprising a turbojet housed in a nacelle according to the invention, each propulsion assembly of each pair being placed symmetrically relative to a longitudinal axis of the aircraft. Advantageously, the nacelles are oriented so as to allow their door to open in a direction at right angles to the fuselage. In the case of a nacelle according to the present invention providing a reorientation of its exhaust flow only with the aid of the reverser door, the system dispenses with an airfoil or other element of the aircraft and may be incorporated in any location of the latter.

### BRIEF DESCRIPTION OF THE DRAWINGS

The application of the invention will be better understood with the aid of the detailed description that is presented below with reference to the appended drawing in which:

FIG. 1 is a schematic representation in front view of an aircraft fitted with two propulsion assemblies placed on either side of the fuselage and each comprising a nacelle according to the invention.

FIG. 2 is a schematic representation in perspective of a downstream section of a nacelle according to the invention having the thrust reverser door in the open position.

FIG. 3 is a schematic representation in side view of the downstream section of FIG. 2.

FIG. 4 is a schematic representation in rear view of the downstream section of FIG. 2.

FIG. 5 is a schematic representation in side view of the downstream section of FIG. 3 showing the thrust reverser door in the closed position.

FIG. 6 is a schematic representation of a locking system particularly designed for the downstream section of FIGS. 2 to 5.

### DETAILED DESCRIPTION OF THE INVENTION

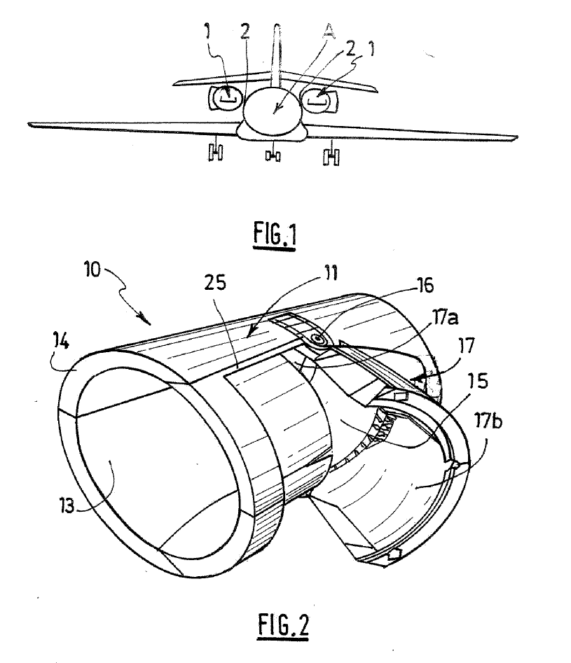

A nacelle 1 according to the invention, as shown in FIG. 1 mounted on an aircraft A, forms a tubular housing for a turbojet (not visible) from which it is used to channel the air flow or flows that it generates.

The nacelle 1 is more particularly designed to be fixed to a side of the fuselage of the aircraft by means of a pylon 2.

More precisely, the nacelle 1 has a structure comprising a front section forming an air inlet, a downstream section surrounding a fan of the turbojet and a downstream section 10 surrounding the turbojet and containing a thrust reverser system. This downstream section 10 may be extended by a section forming an exhaust nozzle.

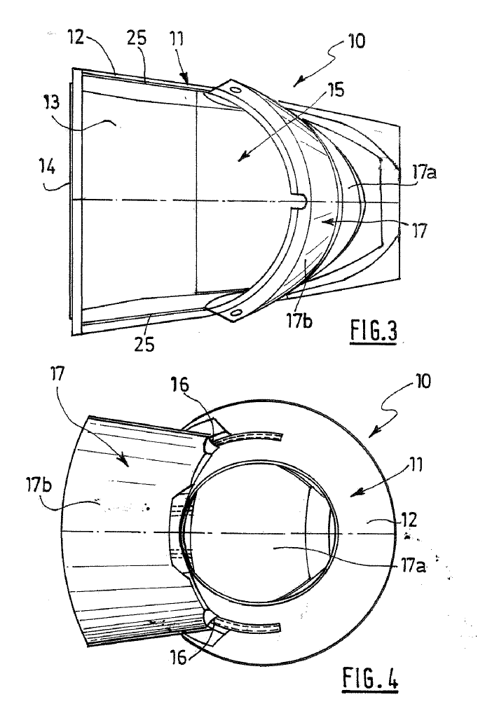

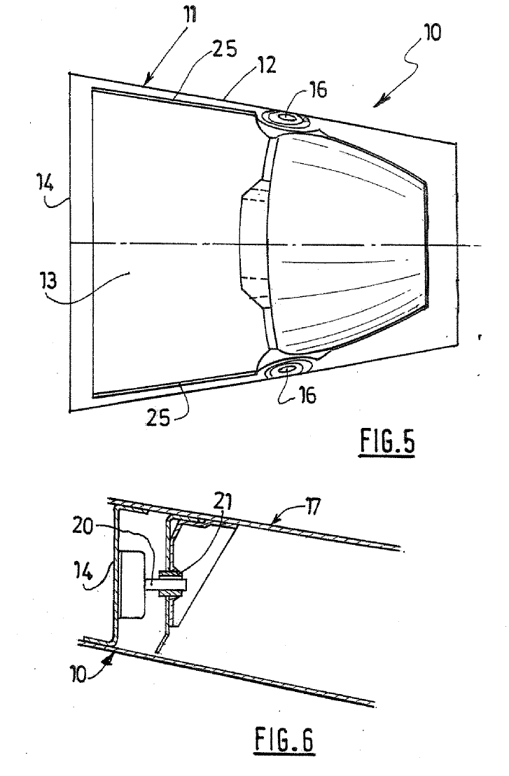

Only the downstream section will be described in detail below and only said section is represented in FIGS. 2 to 5.

The downstream section 10 has a substantially tubular and frustoconical shape comprising a fixed structure 11 having an outer surface 12 and an inner surface 13 connected upstream by a front peripheral frame 14 and joining downstream in a single plane via a thin and constant section.

This fixed structure 11 has a recess defining a side opening 15 on which pivot shafts 16 supporting a door 17 are mounted.

Said door 17 is capable of swinging about an axis defined by the pivot shafts 16 between a first closed position in which it closes off the side opening 15 and ensures the aerodynamic continuity of the outer surface 12 and of the inner surface 13 of the fixed structure 11 and an open position in which a downstream portion 17a of the door 17 moves at least partially into the downstream section, therefore being capable of blocking a portion of the direct jet air flow and of orienting it through the opening 15 where an upstream portion 17b of the door 17 completes its reorientation in a direction oriented toward the front of the nacelle 1.

The general structure of the door 17 is not the subject of the present invention and reference should be made to the knowledge of those skilled in the art in the field concerned.

For maximum efficiency and in order to comply with the air pressure conditions for optimum operation of the turbojet, a definition will be given of an opening 15 and a location of the pivot shafts 16 calculated so that the thrust reverser section of the opening 15, that is to say substantially the section of the upstream portion 17b of the door 17, is substantially equal to double the section of the downstream portion 17a of the door 17 closing off the downstream section 10. Evidently this surface area ratio is given only as an example and may be adapted according to the operating data of the turbojet.

The door 17 is actuated by means of an actuator (not shown) of the hydraulic, pneumatic or electric cylinder type having a first end fixed in the door 17 and a second end fixedly attached to the fixed portion 11, preferably mounted on the front frame 14. Advantageously, the first end is fixed on a longitudinal midline of the door 17.

The downstream section 10 is also fitted with means for locking the door 17 in the closed position. The locking system is shown in greater detail in FIG. 6.

Each locking system comprises a shear pin 20 mounted so as to be movable in translation in a direction perpendicular to the front frame 14. This shear pin 20 is capable of interacting with a matching bore 21 arranged in the thickness of the door 17.

Therefore, when the door 17 is in the closed position so that its thickness faces the front frame 14, the shear pin 20 is actuated to enter the matching bore 21. The door 17 is then locked in rotation. In the same manner, to allow the door 17 to be opened, it is sufficient to retract the shear pin 20.

Advantageously, the door 17 interacts with two locking systems each placed at an end of said door 17.

In order to be able to carry out a locking operation without load being applied to the locking means, it is usual to provide an overretraction of the movable portion.

Such an overretraction is allowed in this instance by making in the door 17 bores 21 having a diameter that is greater than the diameter of the corresponding shear pin 20 but ensuring that the axis of the shear pin 20 is aligned with the center of the bore 21 only when the door 17 is in its overretracted position.

It follows that, in the normal closed position of the door 17, the shear pin butts firmly against an inner wall of the matching bore 21 thereby allowing a more reliable locking with no disruptive functional clearance.

Evidently, such a locking system via a shear pin allowing an overretraction may be applied to other movable portions of the nacelle, particularly to access hatches.

It is understood from the description that the nacelle according to the invention having a downstream section 10 as described may be fitted with an actuation system and locking system that are lighter and therefore more economical.

A reduced manufacturing cost will also be noted.

Specifically, as mentioned above, a downstream section 10 has a considerable fixed structure 11 advantageously able to be produced from a reduced number of elements in order to limit the assembly of said elements and the aerodynamic unevennesses that arise therefrom.

An advantageous method for producing said fixed structure will be to produce each of the outer surface and the inner surface 13 in a single piece. The general shape of each of these two surfaces 12, 13 being frustoconical, they may be easily nested one in the other. It is then sufficient simply to finish the fixed structure 11 by connecting the two surfaces 12, 13 upstream via the front frame 14 and downstream after having adjusted each nested part one to the other.

Evidently, in addition to the front frame, the user will also provide walls 25 of side fasteners connecting the outer surface 12 and the inner surface 13 at the opening 15.

From the drawings it will be also noted that the door 17 allows a relatively considerable opening 15 to be opened up that may allow an operator easy access to the inside of the nacelle 1 for maintenance operations. This will if necessary make it possible to dispense with certain access hatches and in particular fan or other covers.

Although the invention has been described in connection with particular exemplary embodiments, it is evident that it is in no way limited thereto and that it comprises all the technical equivalents of the means described and their combinations if the latter form part of the invention.

1. A nacelle for a turbojet comprising:
an air inlet structure capable of channeling an air flow toward a fan of the turbojet,
a middle structure designed to surround said fan and a downstream section fitted with a pivoting-door thrust reverser system comprising a single thrust reverser door mounted so as to pivot between a closed position in which it allows an air flow to travel from the turbojet in a direct jet and in which it ensures the internal and external aerodynamic continuity of the nacelle and an open position in which it pivots toward a position substantially perpendicular to the axis of the nacelle,
a downstream portion of said door moving inside the nacelle to close off at least a portion of the air flow of the turbojet and direct it in a direction oriented toward the front of the nacelle,
wherein the downstream section, has downstream of the door, a ring extending over a whole periphery.

2. The nacelle as claimed in claim 1, wherein the ring forms an exhaust nozzle.

3. The nacelle as claimed in claim 1, wherein the pivoting door is designed to make it possible to open up, upstream of its pivot axis, a reverse jet discharge section equal to twice a section closed off by said door in the reverse thrust position.

4. The nacelle as claimed in claim 1, wherein the thrust reverser system comprises a single means of actuating the door fixed upstream of the latter substantially on a longitudinal midline.

5. The nacelle as claimed in claim 1, wherein the thrust reverser system comprises means for locking the door in the closed position taking the form of a shear pin capable of interacting with a matching bore arranged in the thickness of the door.

6. The nacelle as claimed in claim 5, wherein the bore has a diameter that is greater than a diameter of the matching shear pin and is situated in an eccentric manner relative to said shear pin so that, in the closed position, the shear pin exerts a pressure against an inner surface of the bore and requires an overretraction in order to be engaged and/or disengaged without force.

7. The nacelle as claimed in claim 1, wherein the downstream section has a fixed structure comprising an outer surface and an inner surface, said inner and/or said outer surface each being made in a single piece, the fixed structure then preferably being obtained by fitting together the two structures of substantially frustoconical shape.

8. The nacelle as claimed in claim 1, wherein the downstream section has, upstream of the door, a front frame extending over the whole periphery of the downstream section.

9. An aircraft comprising at least a pair of propulsion assemblies each comprising a turbojet housed in a nacelle as claimed in claim 1, each propulsion assembly of each pair being placed symmetrically relative to a longitudinal axis of the aircraft.

10. The aircraft as claimed in claim 9, wherein the nacelles are oriented so as to allow the thrust reverser door to open in a substantially horizontal plane toward an outside of the aircraft.
